(19) United States
(12) Patent Application Publication
(10) Pub. No.: US 2010/0078043 A1
(43) Pub. Date: Apr. 1, 2010

(54) CLEANING DEVICE AND CLEANING METHOD

(76) Inventors: Masaki KITABATA, Toyama (JP); Shin-ichi Imai, Osaka (JP)

Correspondence Address: MCDERMOTT WILL & EMERY LLP, 600 13TH STREET, NW, WASHINGTON, DC, 20005-3096, US

(21) Appl. No.: 12/569,053

(22) Filed: Sep. 29, 2009

(30) Foreign Application Priority Data
Sep. 30, 2008 (JP) 2008-253188

(51) Int. Cl. B08B 3/00

(52) U.S. Cl. 134/10; 134/104.2

(57) ABSTRACT

An initial resistivity value of pure water is measured. A lifter is cleaned in a state where the pure water is continuously supplied to the rinsing tank to replenish the rising tank while the pure water is being drained from the rinsing tank. A resistivity value of the pure water in process of cleaning the lifter is measured at predetermined time intervals. A difference value between each of the resistivity values and the initial resistivity value is calculated, and the calculated difference values are integrated. An amount of residual chemical solution of the lifter in process of being cleaned is calculated based on an integration result thus obtained. A period of cleaning time necessary for the lifter to become clean in a state where a flow rate of the drained/replenishing pure water per unit time is maintained is calculated based on the amount of residual chemical solution. The lifter is continuously cleaned in the state where the flow rate of the drained/replenishing pure water per unit time is maintained until the period of cleaning time elapses.

### BACKGROUND OF THE INVENTION

1. Field of the Invention

The present invention relates to a cleaning device and a cleaning method used in a semiconductor substrate treating process and more particularly to a cleaning device and a cleaning method for performing a final rinsing step of a wet treatment.

2. Description of the Related Art

In this specification of the present patent application, the entire recitations of the Japanese Patent Application No. 2008-253188 filed on Sep. 30, 2008, including its specification, drawings and Scope of Claims, are hereby incorporated by reference.

As is well known in the art, a ultrapure water rinsing method (an overflow rinsing method) is conventionally adopted in a semiconductor substrate cleaning method. The overflow rinsing method is aimed at thoroughly cleaning a semiconductor substrate by removing chemical solution attached thereto after a chemical solution treatment using a solution in which hydrochloric acid and hydrogen peroxide water are mixed, a solution in which ammonium and hydrogen peroxide water are mixed, a solution in which concentrated sulfuric acid and hydrogen peroxide are mixed, or the like, is given to the semiconductor substrate.

In a soak cleaning device wherein multiple tanks are used, a process control system, wherein a resistivity value of pure water is measured and monitored in a final rinsing tank during the cleaning process in order to confirm a cleaning effect of the semiconductor substrate, and the cleaning process ends when the resistivity value of pure water in the tank rises to finally reach an expected level (the resistivity value of pure water increases when the semiconductor substrate is cleaned to such an extent that no impurities are left in the water in the tank), is conventionally employed.

### SUMMARY OF THE INVENTION

In the conventional technology, however, a cleaning time during which the chemical solution is removed from the semiconductor substrate and the contents of the rinsing tank are completely replaced with ultrapure water is inevitably increased in the case where a considerable amount of the chemical solution is brought into the rinse treatment after the chemical solution treatment. Usually, the surface of the semiconductor substrate is not etched in the rinsing tank, unlike in the chemical solution treatment. However, when a large amount of chemical solution is attached to a lifter which retains the semiconductor substrate, a considerable amount of the chemical solution is brought into the rinsing tank. As a result, the concentration of the chemical solution becomes high and accordingly the cleaning time is increased, whereby there are cases where the surface of the semiconductor substrate is etched in the rinse treatment. As a conventionally-known fact, an organic chemical solution containing phosphoric acid or the like tends to be attached, in quantity, to the lifter.

In the case of a semiconductor substrate provided with a thin film formed on a surface thereof, in particular, etching causes a large impact thereon, for example, the characteristics of such a semiconductor substrate tend to deteriorate and its yielding tends to be lowered. Therefore, a semiconductor device comprising a semiconductor substrate overly etched in its chemical solution treatment tank and rinsing tank is inferior in performance, quality and reliability. Further, the semiconductor device comprising the semiconductor substrate thus characterized is inferior in productive efficiency and therefore, its production costs are high. A semiconductor substrate having a minute circuit pattern comprises a very thin film formed on a surface thereof, and it is very important to control an etching amount in the semiconductor substrate. Therefore, it is desirable to remove as much chemical solution attached to the lifter as possible when the semiconductor substrate is subjected to the chemical solution treatment and rinse treatment.

Further, since a period of cleaning time is not fixed, it varies, that is, becomes longer or shorter depending on the amount of chemical solution attached to the semiconductor substrate or the lifter. In the case where a period of cleaning time changes in one of treating tanks in a cleaning device comprising a plurality of treating tanks, other treating tanks have to wait for the cleaning treatment to be completed.

Therefore, it is difficult to conduct a plurality of treating processes subject to different conditions in parallel with one another.

Therefore, a main object of the present invention is to reliably reduce the amount of chemical solution attached to a lifter which will be brought into a rinsing tank.

A cleaning method according to the present invention is a method of cleaning a lifter for retaining a semiconductor substrate provided in a soak cleaning device for the semiconductor substrate, comprising:

a step of measuring an initial resistivity value of pure water in a state where the pure water is supplied to a rinsing tank for cleaning the lifter;

a step of cleaning the lifter in a state where the pure water is continuously drained from and added to the rinsing tank to which the pure water is being supplied;

a step of measuring the resistivity value of the pure water with which the lifter is cleaned, at predetermined time intervals;

a step of calculating a difference value between each of the resistivity values measured at the predetermined time intervals and the initial resistivity value;

a step of integrating the difference values and calculating an amount of residual chemical solution of the lifter being in the cleaning treatment based on an integration result of the difference values;

a step of calculating a period of cleaning time necessary for the lifter to become clean in a state where a flow rate of the drained/replenishing pure water per unit time is maintained based on the amount of residual chemical solution; and

a step of continuing to clean the lifter in the state where the flow rate of the drained/replenishing pure water per unit time is maintained until the period of cleaning time elapses.

According to another aspect of the lifter cleaning method according to the present invention, the lifter cleaning method comprises the following steps in place of the step of calculating the period of cleaning time and the step of continuing to clean the lifter:

a step of calculating a flow rate of the drained/replenishing pure water per unit time necessary for the lifter to become clean, in a state where a period of cleaning time necessary for the lifter to be clean is fixed, based on the amount of residual chemical solution and

a step of continuing to clean the lifter until the fixed period of cleaning time elapses in a state where the pure water is supplied to the rinsing tank in accordance with the calculated flow rate of the drained/replenishing pure water per unit time.

A cleaning device according to the present invention is a cleaning device for cleaning a lifter for retaining a semiconductor substrate provided in a soak cleaning device for the semiconductor substrate, comprising:

a rinsing tank for cleaning the lifter with pure water;

a pure water supplier for continuously supplying the pure water to the rinsing tank to replenish the rinsing tank while the pure water is being drained from the rinsing tank;

a resistivity value measurer for measuring an initial resistivity value of the pure water before the cleaning of the lifter in the rinsing tank and a resistivity value of the pure water in process of cleaning the lifter, the resistivity value measurer measuring the resistivity value of the pure water in process of cleaning the lifter at predetermined time intervals;

a calculator/analyzer for calculating a difference value between each of the resistivity values of the pure water in process of cleaning the lifter and the initial resistivity value, integrating the calculated difference values, and calculating an amount of residual chemical solution of the lifter based on an integration result thereby obtained, the calculator/analyzer further calculating a period of cleaning time necessary for the lifter to become clean, in a state where a flow rate of the drained/replenishing pure water per unit time is maintained, based on the calculated amount of residual chemical solution; and

a controller for continuing the drainage/replenishment of the pure water with respect to the rinsing tank performed by the pure water supplier in the state where the flow rate of the drained/replenishing pure water per unit time is maintained until the period of cleaning time calculated by the calculator/analyzer elapses.

According to another aspect of the cleaning device according to the present invention, the lifter cleaning device comprises a calculating/analyzer and a controller constituted as described below in place of the before-mentioned calculator/analyzer and controller. The lifter cleaning device comprises:

a calculator/analyzer for calculating a difference value between each of the resistivity values of the pure water during the cleaning of the lifter and the initial resistivity value, integrating the calculated difference values, and calculating an amount of residual chemical solution of the lifter based on an integration result thereby obtained, the calculator/analyzer further calculating a flow rate of the drained/replenishing pure water per unit time necessary for the lifter to become clean, in a state where a period of cleaning time necessary for the lifter to be clean is fixed, based on the calculated amount of residual chemical solution; and

a controller for continuing the drainage/replenishment of the pure water with respect to the rinsing tank performed by the pure water supplier in accordance with the flow rate of the drained/replenishing pure water per unit time calculated by the calculator/analyzer until the fixed period of cleaning time elapses.

According to the cleaning device and the cleaning method provided by the present invention, the lifter is continuously cleaned with the pure water until the period of cleaning time necessary for the lifter to become clean elapses or until the fixed period of cleaning time elapses on condition that the pure water is supplied in accordance with such a flow rate that is sufficient enough for the lifter to become clean. As a result, the chemical solution attached to the lifter can be lessened.

According to the cleaning device and the cleaning method provided by the present invention, after the chemical solution attached to the lifter which retains the semiconductor substrate is lessened, the semiconductor substrate, from which the chemical solution was cleaned, can be rinsed. Therefore, the surface of the semiconductor substrate can be protected from any unnecessary etching given thereto, which conventionally occurs when the chemical solution is brought into the rinsing tank.

In the case of a semiconductor substrate provided with a thin film formed on a surface thereof, in particular, etching causes a large impact thereon, and its characteristics tend to deteriorate and its yielding tends to be lowered. According to the cleaning device and the cleaning method provided by the present invention, the surface of the semiconductor substrate can be protected from any unnecessary etching given thereto in the chemical solution treating tank and the rinsing tank. As a result, the performance, quality and reliability of the semiconductor substrate can be protected and the yield can be retained.

According to the cleaning device and the cleaning method provided by the present invention, the cleaning can be performed by controlling the flow rate of the pure water in accordance with the amount of residual chemical solution in a state where the period of cleaning time is fixed. More specifically, in a state where the period of cleaning time is fixed, the flow rate of the pure water to be supplied is increased when there is a large amount of residual chemical solution, while the flow rate of the pure water to be supplied is reduced when there is a small amount of residual chemical solution. Therefore, the period of cleaning time can be kept constant in a cleaning device comprising a plurality of treating tanks while the cleanness of the lifter is kept at the same level. As a result, a plurality of treating processes subject to different conditions can be carried out in parallel with one another without a need for one of the treating tanks to wait for the process completion of another treating tank.

According to the cleaning device and the cleaning method provided by the present invention, the cleanness of the lifter can improve, and unnecessary etching by the residual chemical solution on the surface of the semiconductor substrate is prevented from happening when the semiconductor substrate is rinsed. As a result, the deterioration in product quality and the variations due to a manufacturing process in a miniaturized device can be lessened.

### BRIEF DESCRIPTION OF THE DRAWINGS

These and other objects of the invention will become clear by the following description of preferred embodiments of the invention and be specified in the claims attached hereto. A number of benefits not recited in this specification will come to the attention of the skilled in the art upon the implementation of the present invention.

FIG. 1 is a schematic illustration of a constitution of a cleaning device according to a preferred embodiment of the present invention.

FIG. 2 is a flow chart of a lifter cleaning method according to the preferred embodiment.

FIG. 3 is a drawing illustrating the transition of resistivity values shown when the lifter is cleaned according to the preferred embodiment.

FIG. 4 is a drawing illustrating the transition of resistivity values in working examples shown when the lifter is cleaned according to the preferred embodiment.

### DETAILED DESCRIPTION OF THE INVENTION

Hereinafter, a preferred embodiment of the present invention is described referring to the drawings.

### Preferred Embodiment 1

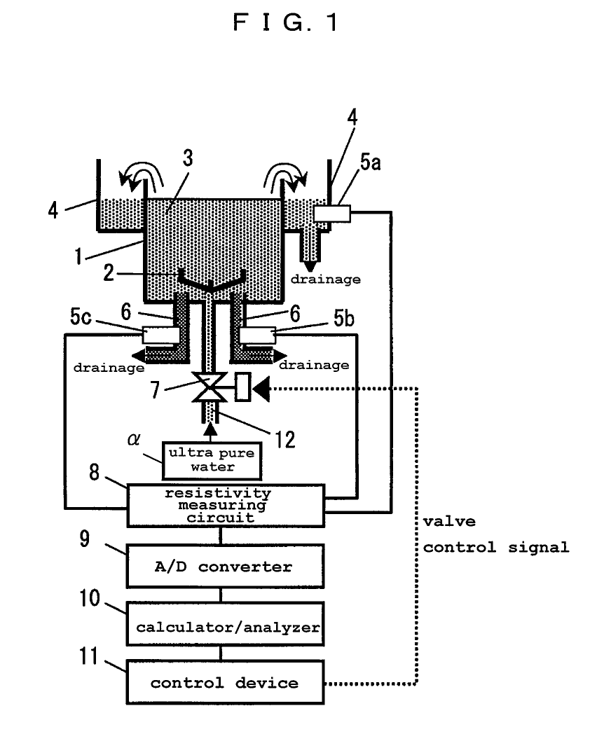

FIG. 1 is a schematic illustration of a constitution of a soak cleaning device according to a preferred embodiment of the present invention. A rinsing tank 1 is a cleaning tank in which one or a plurality of semiconductor substrates cleaned with a chemical solution are contained while being retained by a lifter 2, and the lifter 2 alone is rinsed with pure water after the semiconductor substrate is cleaned. At a bottom section of the rinsing tank 1, a pipe 12 for supplying ultrapure water 3 used for rinsing the semiconductor substrate and the lifter 2 from a pure water supply source a to the rinsing tank 1 is set, and a pure water supply valve 7 is provided in the pipe 12. When the pure water supply valve 7 is opened or closed, the supply of the ultrapure water 3 starts or stops. When the ultrapure water 3 in the rinsing tank 1 (including the chemical solution attached to the semiconductor substrate or the lifter 2) overflows the rinsing tank 1, the rinsing tank 1 is replenished with the ultrapure water 3 in a state where a drainage/replenishing flow rate per unit time is maintained. The ultrapure water 3 overflowing the rinsing tank 1 is temporarily stored in a drainage port 4. At the time, a resistivity measurer 5a set near a drainage place measures a resistivity value of the overflowing ultrapure water 3. In the present preferred embodiment, the rinsing tank 1 which the ultrapure water 3 overflows, the pure water supply valve 7 and the pure water supply source α constitute a pure water supplier.

In the rinsing tank 1, a sampling tube 6 for sampling the ultrapure water 3 in the rinsing tank 1 is provided near the lifter 2. A given amount of the ultrapure water 3 in the periphery of the lifter 2 is constantly sampled by the sampling tube 6, and the resistivity value thereof is measured by resistivity measurers 5b and 5c. Hereinafter, resistivity values of the ultrapure water 3 measured by the resistivity measurers 5a, 5b and 5c are called measurement values (resistivity).

Measurement values (resistivity) are sent to a resistivity measuring circuit 8 in the form of an electrical signal. The resistivity measuring circuit 8 measures an overall resistivity value of the ultrapure water 3 based on the sent measurement values (resistivity) of the ultrapure water 3 obtained at each section of the rinsing tank 1. In the present preferred embodiment, the resistivity measurers 5a, 5b and 5 c and the resistivity measuring circuit 8 constitute a resistivity measurer. Hereinafter, an overall resistivity value of the ultrapure water 3 measured by the resistivity measuring circuit 8 is called an analog measurement value (resistivity). The analog measurement value (resistivity) is an analog signal.

The analog measurement value (resistivity) is transmitted from the resistivity measuring circuit 8 to an A/D converter 9 as an electrical signal. The A/D converter 9 converts the supplied analog measurement value (resistivity) into a digital signal, and then outputs the digital signal to a calculator/analyzer 10. Hereinafter, the analog measurement value (resistivity) converted into the digital signal is called a digital measurement value (resistivity). In the description below, the digital measurement value (resistivity) is often simply referred to as the resistivity value of the ultrapure water 3.

The calculator/analyzer 10 obtains the supplied resistivity value of the ultrapure water 3 at predetermined time intervals from the A/D converter 9. Hereinafter, each time point set at predetermined time intervals is a called an obtaining time point. The calculator/analyzer 10 further integrates the resistivity values of the ultrapure water 3 when the obtained resistivity value of the ultrapure water 3 satisfies a requirement previously set.

A controller 11 predicts a period of cleaning time necessary for cleaning the lifter 2 based on an integration result of the resistivity value of the ultrapure water 3 obtained by the calculator/analyzer 10, and causes the lifter 2 to be cleaned until the predicted period of cleaning time elapses in a state where the ultrapure water 3 is continuously drained and then simultaneously added. After the elapse of the cleaning time, the controller 11 transmits a valve control signal to the pure water supply valve 7 to cause the supply of the ultrapure water 3 to the rinsing tank 1 to be stopped.

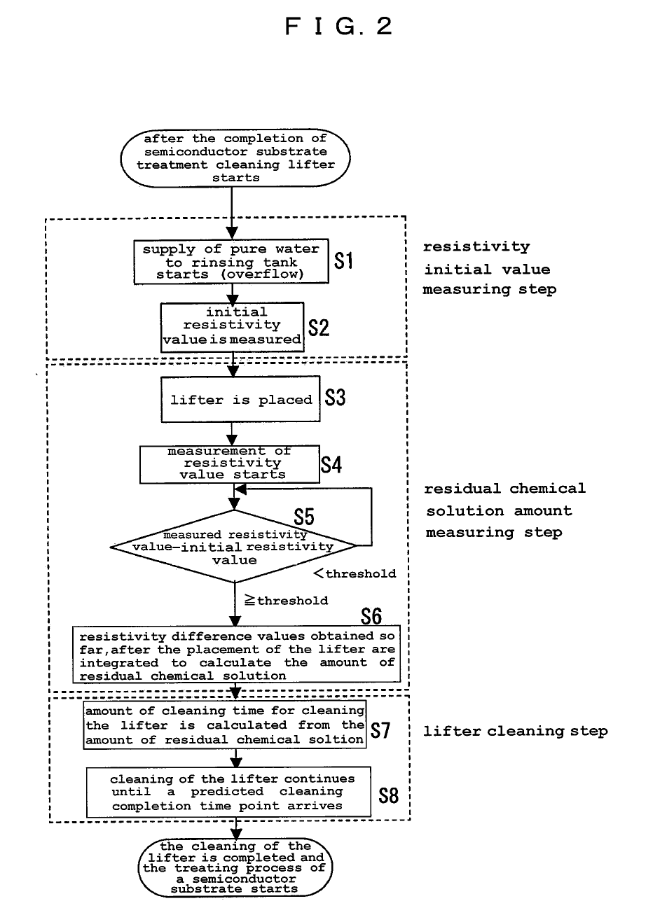

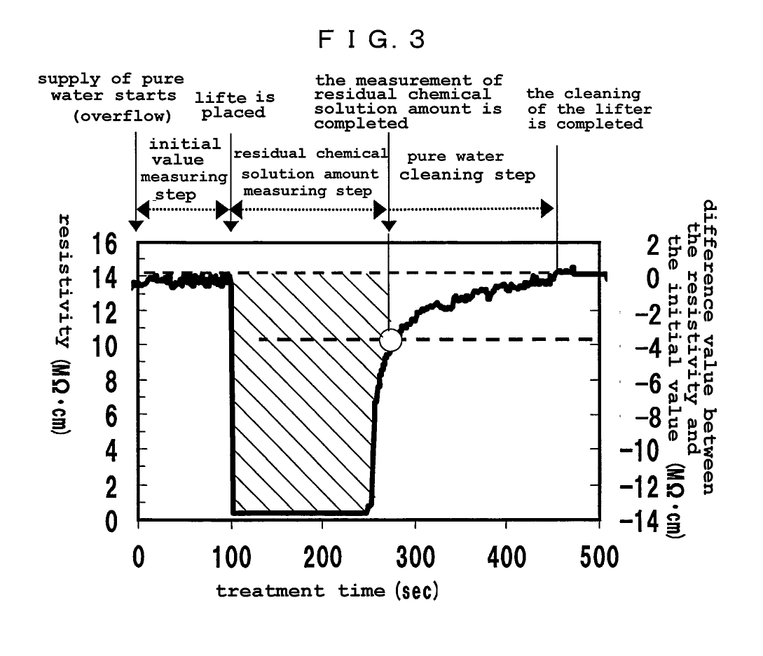

Next, a method of cleaning the lifter 2 after cleaning the semiconductor substrate is described referring to FIGS. 2 and 3. In the method of cleaning the lifter 2 according to the present preferred embodiment, chemical solution which was attached to the lifter 2 when chemical solution was cleaned and cannot be completely removed from the lifter 2 while the semiconductor substrate is cleaned is cleaned/removed from the lifter 2 in the rinsing tank 1 after the cleaning of the semiconductor substrate. The cleaning method is roughly divided into the following three steps. A first step is a step of measuring an initial resistivity value, a second step is a step of measuring an amount of residual chemical solution, and a third step is a step of cleaning a lifter. These steps are described in detail below.

First, the step of measuring an initial resistivity value is described below. In the rinsing tank 1 where the chemical solution treatment was over and the rinse treatment for one or a plurality of semiconductor substrates has been completed, the pure water supply valve 7 is opened so that the rinsing tank 1 is filled with the ultrapure water 3, and the ultrapure water 3 is further supplied to overflow the rising tank 1, so that the ultrapure water 3 in the rinsing tank 1 is sufficiently clean (S1). The overflow of the ultrapure water is continued for a certain period of time, and measurement values (resistivity) are thereafter measured by the resistivity measurers 5a, 5b and 5c for a preset time period. The resistivity measuring circuit 8 measures the analog measurement value (resistivity) of the ultrapure water 3 based on the measurement values (resistivity) of the resistivity measurers 5a, 5b and 5c. The analog measurement value (resistivity) is converted into a digital signal by the A/D converter 9, and the digital measurement value (resistivity) thus obtained is then stored in the calculator/analyzer 10 as an initial value of the resistivity (hereinafter, referred to as an initial resistivity value) (S2).

Next, the step of measuring an amount of residual chemical solution is described. The lifter 2 which has released the semiconductor substrate after the cleaning treatment of the semiconductor substance is placed into the rinsing tank 1 which the ultrapure water overflows (in a state where the ultrapure water 3 is continuously drained but simultaneously added) (S3). In the rinsing tank 1, the ultrapure water is kept overflowing even after the lifter is placed therein, and the cleaning of the lifter 2 is continuously carried out. While the lifter is being cleaned, the resistivity value of the ultrapure water is measured at predetermined time intervals (S4). A difference value between each of the resistivity values of the ultrapure water 3 at obtaining time points thus obtained and the initial resistivity value is calculated by the calculator/analyzer 10 (S5).

The measurement values (resistivity) measured by the resistivity measurers 5a-5c are supplied to the resistivity measuring circuit 8. The resistivity measuring circuit 8 measures an analog measurement value (resistivity) of the ultrapure water 3 based on the measurement values (resistivity). The A/D converter 9 converts the analog measurement value (resistivity) into a digital measurement value (resistivity). The calculator/analyzer 10 obtains the digital measurement value at each of the obtaining time points. The digital measurement value (resistivity) obtained by the calculator/analyzer 10 serves as a resistivity value of the ultrapure water 3 at each of the measuring time points (obtaining time points) in the pure water rinse treatment. The calculator/analyzer further calculates the difference value between the resistivity value of the ultrapure water 3 obtained at each of the obtaining time points in the pure water rinse treatment and the initial resistivity value. Hereinafter, the difference value is called a difference value (resistivity). The calculator/analyzer 10 further analyzes at each of the obtaining time points if each of the calculated difference values (resistivity) is at least a threshold value previously set. In the present preferred embodiment wherein the threshold value is set at “−4”, the calculator/analyzer 10 analyzes if each of the difference values (resistivity) is at least the threshold value “−4”. Hereinafter, a time point at which the difference value (resistivity) is equal to or exceeds the threshold value is referred to as a time point (over-threshold).

At a time point (over-threshold), the calculator/analyzer 10 integrates the difference values (resistivity) at the obtaining time points included in a time period between the time when the lifter was placed in the rinsing tank 1 and the time point (over-threshold), and calculates the amount of residual chemical solution of the lifter 2 based on an integration result thereby obtained. A possible example of the method of calculating the amount of residual chemical solution is to multiply the integration result of the difference value (resistivity) by a certain coefficient. In the case where the actual amount of residual chemical solution shows a value which is previously known, the coefficient can be calculated from “actual amount of residual chemical solution”/“integration result of difference value (resistivity)”. If the coefficient for calculating the amount of residual chemical solution is unknown in the present invention, “1” may be used as the coefficient, in which case the integration result of the difference value (resistivity)=the amount of the residual chemical solution.

Finally, the step of cleaning the lifter is described. The controller 11 calculates the period of cleaning time necessary for the lifter 2 to be cleaned, in the state where the flow rate of the drained/replenishing ultrapure water 3 per unit time is maintained, based on the amount of residual chemical solution of the lifter 2 already calculated by means of the following calculation formula (S7).

$$Δ {N}_{c} = - \frac{F}{V} {N}_{c} Δ t$$

$${N}_{c} = {N}_{0} exp ( - \frac{F}{V} t )$$

N_{c}: target amount of residual chemical solution after the cleaning of lifter: initial set value
Nₒ: amount of residual chemical solution of the lifter 2
F: flow rate of the drained/replenishing ultrapure water 3 per unit time (l/min.): initial set value
V: volume of the rinsing tank 1 (l): initial set value
t: cleaning time (min.): variably controlled

In the calculation formula, it is necessary to decide in advance the flow rate F of drained/replenishing ultrapure water 3 per unit time and the volume V of the rinsing tank 1 as initial setting. The target amount N_{c} of residual chemical solution after the cleaning of the lifter denotes an amount of residual chemical solution with respect to a semiconductor substrate or the like which will be manufactured by means of the cleaned lifter 2, and the value N_{c} can be identified depending on the characteristics and quality of a semiconductor substrate to be manufactured. More specifically, the target amount N_{c} of residual chemical solution is set through experiments conducted beforehand.

When the data described so far is set in advance, a period of time necessary for the amount Nₒ of residual chemical solution of the lifter 2 to reach a value requested as its target can be calculated through the calculation of the amount Nₒ of residual chemical solution of the lifter 2 at each of the obtaining time points. When the flow rate F of drained/replenishing ultrapure water 3 per unit time, the volume V of the rinsing tank 1 and the target amount N_{c} of residual chemical solution are preset in the calculator/analyzer 10 as initial values in these calculations, the calculator/analyzer 10 can calculate the period of cleaning time t of the lifter 2. For the duration of the calculated lifter cleaning time t, the lifter 2 is rinsed with pure water in the state where the flow rate F of the drained/replenishing pure water 3 per unit time is maintained. As a result, the residual chemical solution can be sufficiently removed from the lifter 2 (S8). Consequently, the chemical solution treatment and the rinse treatment for semiconductor substrates that follow can be continued.

In the description of the preferred embodiment given so far, the lifter 2 is rinsed with the ultrapure water 3; however, a chemical solution containing fluorine or the like may be used. In the case where the lifter 2 is made of quartz and an organic chemical solution containing phosphoric acid or the like which has a high viscosity is attached to the lifter 2, the lifter 2 is preferably cleaned with fluorine because the chemical solution attached thereto can be thereby more effectively removed. As a result, a period of time necessary for removing the chemical solution attached to the lifter 2 can be shortened. When the lifter 2 is cleaned with the chemical solution containing fluorine or the like, however, it is necessary to remove the fluorine using pure water in the same manner as described so far.

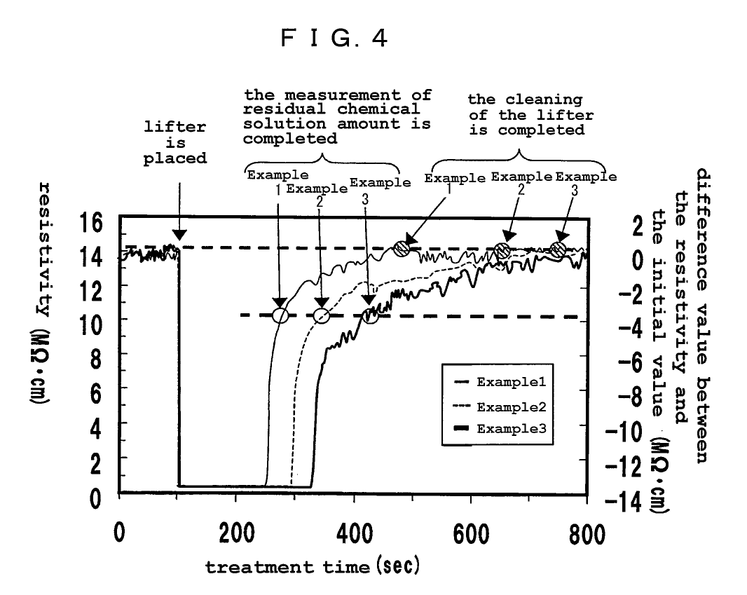

FIG. 4 is a drawing which illustrates the transition of the resistivity values shown when the lifter 2 is cleaned according to the preferred embodiment and timing of the completion of each step illustrated in FIG. 2. Examples 1-3 present data obtained when the lifters 2 having different amounts of residual chemical solution are cleaned. The amount of residual chemical solution of the lifter 2 is calculated when a difference between each of the resistivity values at time points in the Examples 1-3 and the initial resistivity value reaches at least “−4 or any other threshold value” after the resistivity value starts to rise.

In FIG. 4, the amount of residual chemical solution of the lifter 2 is increased in the following order: Example 3>Example 2>Example 1. The period of cleaning time of the lifter is calculated, in each case, based on the amount of residual chemical solution thus calculated, and the lifter is, in each case, cleaned during the calculated period of cleaning time. Since the lifter cleaning time is calculated in accordance with the amount of residual chemical solution of the lifter 2 and the lifter 2 is accordingly cleaned, the lifter 2 can be constantly kept clean without the deterioration of the characteristics and quality of the semiconductor substrate, and therefore, the amount of the ultrapure water 3 to be used can be reduced to minimum. As a result, cost reduction can be achieved.

The flow rate F of drained/replenishing ultrapure water 3 per unit time may be controlled in accordance with the amount of residual chemical solution of the lifter 2 in a state where the period of cleaning time necessary for the lifter 2 to become clean is fixed. More specifically, the flow rate of the ultrapure water 3 for cleaning the lifter 2 is calculated in the controller 11 according to the following calculation formula.

$$\begin{matrix}Δ {N}_{c} = - \frac{F}{V} {N}_{c} Δ t \\ {N}_{c} = {N}_{0} exp ( - \frac{F}{V} t )\end{matrix}$$

N_{c}: target amount of residual chemical solution after the cleaning of the lifter: initial set value
Nₒ: amount of residual chemical solution of the lifter 2
F: flow rate of the drained/replenishing ultrapure water 3 per unit time (l/min.): variably controlled
V: volume of the rinsing tank 1 (l): initial set value
t: cleaning time (min.): initial set value

These calculation formulas are the same as those described earlier in that the period of cleaning time is calculated in accordance with the amount of residual chemical solution of the lifter 2, but different form those in initial values to be set in advance. In these formulas, the volume V of the rinsing tank 1, the cleaning time t and the target amount N_{c} of residual chemical solution after the cleaning of the lifter are set at their initial values in the calculator/analyzer 10. Then, the amount Nₒ of residual chemical solution of the lifter 2 is calculated, and the calculated value is assigned to the foregoing formulas. By doing so, it becomes possible to calculate the flow rate F of the drained/replenishing ultrapure water 3 per unit time necessary for the lifter 2 to become clean in the state where the period of cleaning time necessary for the lifter 2 to become clean is fixed.

Thus controlled, the flow rate of the ultrapure water 3 to be supplied is increased when a large amount of residual chemical solution is detected in the lifter 2, while the flow rate of the ultrapure water 3 to be supplied is reduced when a small amount of residual chemical solution is detected in the lifter 2, in the state where the period of cleaning time necessary for the lifter 2 to become clean is fixed. Accordingly, the period of cleaning time can be kept constant while the cleanness of the lifter 2 is kept at the same level. Though not shown in the drawings, a cleaning device comprising a plurality of treating tanks is now generally used. In the cleaning device thus constituted, it is not possible to estimate the time point when the cleaning treatment is completed because the end of the cleaning time needs to be detected while the resistivity value is continuously measured in real time. Therefore, it has been conventionally difficult to perform a plurality of treating processes subject to different conditions in parallel with one another. However, according to the method described in the present preferred embodiment, since the period of cleaning time can be kept constant, a plurality of treating processes subject to different conditions can be easily scheduled.

In the preferred embodiment described so far, the A/D converter 9 is provided between the resistivity measuring circuit 8 and the calculator/analyzer 10; however, the A/D converter 9 is not an indispensable structural component. When the resistivity measuring circuit 8 and the calculator/analyzer 10 are configured to process the same type of signal, whether analog or digital, it is unnecessary to provide the A/D converter 9.

In the preferred embodiment described so far, the calculator/analyzer 10 and the controller 11 are structured in a way that a calculating/analyzing section and a control section are independently provided. However, the calculating/analyzing section and the control section may be integrated into a single section.

While there has been described what is at present considered to be preferred embodiments of this invention, it will be understood that various modifications may be made therein, and it is intended to cover in the appended claims all such modifications as fall within the true spirit and scope of this invention.

What is claimed is:

1. A method of cleaning a lifter for retaining a semiconductor substrate provided in a soak cleaning device for the semiconductor substrate, comprising:
a step of measuring an initial resistivity value of pure water in a state where the pure water is supplied to a rinsing tank for cleaning the lifter;
a step of cleaning the lifter in a state where the pure water is continuously drained from and added to the rinsing tank to which the pure water is being supplied;
a step of measuring the resistivity value of the pure water with which lifter is cleaned, at predetermined time intervals;
a step of calculating a difference value between each of the resistivity values measured at the predetermined time intervals and the initial resistivity value;
a step of integrating the difference values and calculating an amount of residual chemical solution of the lifter being in the cleaning treatment based on an integration result of the difference values;
a step of calculating a period of cleaning time necessary for the lifter to become clean, in a state where a flow rate of the drained/replenishing pure water per unit time is maintained, based on the amount of residual chemical solution; and
a step of continuing to clean the lifter, in the state where the flow rate of the drained/replenishing pure water per unit time is maintained, until the period of cleaning time elapses.

2. A method of cleaning a lifter for retaining a semiconductor substrate provided in a soak cleaning device for the semiconductor substrate, comprising:
a step of measuring an initial resistivity value of pure water in a state where the pure water is supplied to a rinsing tank for cleaning the lifter;
a step of cleaning the lifter in a state where the pure water is continuously drained from and added to the rinsing tank to which the pure water is being supplied;
a step of measuring the resistivity value of the pure water with which the lifter is cleaned, at predetermined time intervals;
a step of calculating a difference value between each of the resistivity values measured at the predetermined time intervals and the initial resistivity value;
a step of integrating the difference values and calculating an amount of residual chemical solution of the lifter being in the cleaning treatment based on an integration result of the difference values;
a step of calculating a flow rate of the drained/replenishing pure water per unit time necessary for the lifter to become clean, in a state where a period of cleaning time necessary for the lifter to become clean is fixed, based on the amount of residual chemical solution and
a step of continuing to clean the lifter until the fixed period of cleaning time elapses in a state where the pure water is supplied to the rinsing tank in accordance with the calculated flow rate of the drained/replenishing pure water per unit time.

3. The method of cleaning the lifter as claimed in claim 1, further comprising a step of cleaning the lifter using a fluorine solution prior to the step of continuing to clean the lifter.

4. The method of cleaning the lifter as claimed in claim 2, further comprising a step of cleaning the lifter using a fluorine solution prior to the step of continuing to clean the lifter.

5. The method of cleaning the lifter as claimed in claim 1, wherein the difference values are continuously integrated until the difference value thus obtained reaches a predetermined threshold value in the step of calculating the amount of residual chemical solution of the lifter.

6. The method of cleaning the lifter as claimed in claim 2, wherein the difference values are continuously integrated until the difference value thus obtained reaches a predetermined threshold value in the step of calculating the amount of residual chemical solution of the lifter.

7. A cleaning device for cleaning a lifter for retaining a semiconductor substrate provided in a soak cleaning device for the semiconductor substrate, comprising:
a rinsing tank for cleaning the lifter with pure water;
a pure water supplier for continuously supplying the pure water to the rinsing tank to replenish the rising tank while the pure water is being drained from the rinsing tank;
a resistivity value measurer for measuring an initial resistivity value of the pure water before the cleaning of the lifter in the rinsing tank and a resistivity value of the pure water in process of cleaning the lifter, the resistivity value measurer measuring the resistivity value of the pure water in process of cleaning the lifter at predetermined time intervals;
a calculator/analyzer for calculating a difference value between each of the resistivity values of the pure water in process of cleaning the lifter and the initial resistivity value, integrating the calculated difference values, and calculating an amount of residual chemical solution of the lifter based on an integration result thus obtained, the calculator/analyzer further calculating a period of cleaning time necessary for the lifter to become clean, in a state where a flow rate of the drained/replenishing pure water per unit time is maintained, based on the calculated amount of residual chemical solution; and
a controller for continuing the drainage/replenishment of the pure water with respect to the rinsing tank performed by the pure water supplier in the state where the flow rate of the drained/replenishing pure water per unit time is maintained until the period of cleaning time calculated by the calculator/analyzer elapses.

8. A cleaning device for cleaning a lifter for retaining a semiconductor substrate provided in a soak cleaning device for a semiconductor substrate, comprising:
a rinsing tank for cleaning the lifter with pure water;
a pure water supplier for continuously supplying the pure water to the rinsing tank to replenish the rinsing tank while the pure water is being drained from the rising tank;
a resistivity value measurer for measuring an initial resistivity value of the pure water before the cleaning of the lifter in the rinsing tank and a resistivity value of the pure water in process of cleaning the lifter, the resistivity value measurer measuring the resistivity value of the pure water in process of cleaning the lifter at predetermined time intervals;
a calculator/analyzer for calculating a difference value between each of the resistivity values of the pure water in process of cleaning the lifter and the initial resistivity value, integrating the calculated difference values, and calculating an amount of residual chemical solution of the lifter based on an integration result thereby obtained, the calculator/analyzer further calculating a flow rate of the drained/replenishing pure water per unit time necessary for the lifter to become clean, in a state where a period of cleaning time necessary for the lifter to become clean is fixed, based on the calculated amount of residual chemical solution; and
a controller for continuing the drainage/replenishment of the pure water with respect to the rinsing tank performed by the pure water supplier in accordance with the flow rate of the drained/replenishing pure water per unit time calculated by the calculator/analyzer until the fixed period of cleaning time elapses.

9. The cleaning device as claimed in claim 7, wherein
the resistivity value measurer comprises:
a plurality of sampling tubes for sampling the pure water at a plurality of sections of the rinsing tank;
a plurality of resistivity gauges for measuring resistivity values of the pure water sampled by each of the sampling tubes; and
a resistivity measuring circuit for calculating an overall resistivity value of the pure water based on the resistivity values of the pure water measured by the resistivity gauges at the plurality of sections of the rinsing tank.

10. The cleaning device as claimed in claim 8, wherein
the resistivity value measurer comprises:
a plurality of sampling tubes for sampling the pure water at a plurality of sections of the rinsing tank;
a plurality of resistivity gauges for measuring resistivity values of the pure water sampled by each of the sampling tubes; and
a resistivity measuring circuit for calculating an overall resistivity value of the pure water based on the resistivity values of the pure water measured by the resistivity gauges at the plurality of sections of the rinsing tank.

11. The cleaning device as claimed in claim 7, wherein the calculator/analyzer continuously integrates the difference values until the difference value thus obtained reaches a predetermined threshold value.

12. The cleaning device as claimed in claim 8, wherein the calculator/analyzer continuously integrates the difference values until the difference value thus obtained reaches a predetermined threshold value.
